(19) United States
(12) Patent Application Publication
(10) Pub. No.: US 2012/0317910 A1
(43) Pub. Date: Dec. 20, 2012

(54) CASING FOR OPENINGS OF BUILDINGS WITH ENHANCED THERMAL INSULATION CAPACITY

(76) Inventor: Giuseppe Esposito, Treviso (IT)

(21) Appl. No.: 13/518,664

(22) PCT Filed: Dec. 7, 2010
(86) PCT No.: PCT/IT2010/000488

§ 371 Date: Aug. 7, 2012

(30) Foreign Application Priority Data
Dec. 24, 2009 (IT) VI2009A000309
Mar. 26, 2010 (EP) 10425095.6

(51) Int. Cl. E04B 1/66; E04B 1/70; E06B 1/04

(52) U.S. Cl. 52/302.3

(57) ABSTRACT

A casing (1; 50) for openings of buildings with enhanced thermal insulation capacity comprising a first tubular section (2; 51) which is fixed to the perimetrical wall delimiting the opening, and a second tubular section bar (3; 52), cooperating with the first section bar (2; 51) in order to hermetically close the opening and capable of supporting one or more front panels (4, 5) of interface between the inner environment and the outer environment of the building. At least one of the first section bar (2; 51) and the second section bar (3; 52) presents a plurality of through openings (6; 53) which create within at least one of the tubular section bars (2, 3; 51, 52) a continuous flow of circulating air which, due to the temperature difference between the inner environment and the outer environment, forms a natural thermal barrier in any astronomical season.

The present invention forms part of the building field and, more specifically, concerns a casing with enhanced thermal insulation capacity for openings, such as windows, doors, facades and the like, belonging to any building.

More precisely, the present invention concerns a casing with enhanced thermal insulation capacity of the so-called “closed-joint” type, that is provided with double gaskets positioned one on the outer side and one the inner side, in the ledge section bars of the casing.

The casing comprise welded or open tubular section bars, as well as a reference counter-frame and one or more finishing elements.

As known, there are for long on the market of the field here relevant casings or frames for closing openings of buildings able to keep in a more or less effective manner conditions of thermal insulation inside the environment delimited by the perimetrical walls in which the casing is mounted.

Indeed, one of the main technical features required to the casings is constituted by the high thermal insulation capacity from the atmospheric agents, such as air, or wind, and water which inevitably affect them.

Moreover, another important property required to the casings is represented by the capacity to acoustically isolate the environments or the rooms of buildings from noises coming from the outside, which may disturb the normal and customary work, recreational and/or relax activities of the people.

In addition to these prerogatives, the casings must however present other constructive features, such as the light in case they are of the type that can be opened, in order to be moved by the user without particular difficulties or hindrances, the mechanical strength, the structural strength and the structural non-deformability under the action of the atmospheric agents and the continuous opening and closing cycles, in order to assure a perfect tightness in closing conditions and discourage or effectively clash vandalism acts.

The casing or frames made of wood are notoriously easy to build and present a remarkable capacity of thermal insulation, due to the inherent insulating properties of the wood.

However, considering the increased requirements related to the sizes of the casings and, more in detail, the shape of the panels, especially if made of glass (which are more and more thick and heavy in order to assure adequate insulation and mechanical strength values), mounted on the perimetrical section bars, the casings are often made of wood and/or metallic material such as aluminium and/or steel, as well as wood and/or plastic material such as polyvinylchloride (PVC).

These casings for openings of buildings typically comprise a first tubular section bar made of metallic material, for instance steel, which is fixed to the perimetrical wall delimiting the opening, and a second metallic tubular section bar, cooperating with the first section bar in order to close the opening and supporting one or more front panels of interface between the outer environment of the inner environment of the room of the building.

The tubular section bars present good mechanical and atmosphere agents strength, especially when used to support large glass slabs in casings of relevant sizes, by virtue of the structural strength and non-deformability afforded by the metallic material with which they are made.

Nevertheless, these metallic tubular section bars of the casings of the known type do not give the necessary thermal insulation characteristics.

In order to remedy such a problem, metallic casings have been proposed on the market for some years, commonly known in the field as “thermal break casings”, which include an element made of low thermal conductivity material interposed between the outer tubular section bar and the inner tubular section bar. Such a thermally insulating element limits the heat transfer from the inner environment to the outside, thereby avoiding the formation of thermal bridges usually along the perimeter of doors and windows.

On the other hand, the aforesaid thermal break casings present the recognized drawback of being subject to the so-called “bimetal effect”: the outer tubular section bar and the inner tubular section bar, being at temperatures which differ each other, inevitably suffer non-homogenous thermal expansions which cause dangerous deformations of the section bars themselves, especially if made of aluminium, since, as known, this material is an excellent heat conductor.

This limits at least partially but in any case significantly the air-tightness properties of the casings in closing conditions, thereby causing on one side problems of heat dissipations, on the other side phenomena of infiltration, responsible for the formation and proliferation of moulds and other bacterial colonies, and drastic reduction in the level of acoustic insulation of building rooms.

The constructive solution nowadays widely adopted of interposing an insulating material element in the central section of the casings, between the two tubular section bars which compose it, considerably reduces, therefore, the mechanical strength characteristics of the section bars in question.

It should not forget also that some plastic components present toxicity issues which arise during the process of welding of the section bars, essential process to assure section bars proper structural stability over time.

For the plastic components, in addition, pollution issues relating to the disposal of working scraps and, last but not least, to the dismantling phase of the casing, at the end of the operating cycle.

Furthermore, in some cases, for the type of application to which they are intended, the tubular section bars of the casings should be properly subjected to a process of glazing with which, notoriously, a mechanical part is smoothed, deburred, polished and/or furbished.

In case of traditional thermal break casings, however, such a process of glazing cannot be completed since, providing a significant pressure on the metallic tubular section bar, it would seriously compromise the connection between the insulating material element and the tubular section bar.

Prior art document DT2129779 discloses a casing for openings of buildings of the so-called “open-joint” type, wherein the outer tubular element, produced by aluminium drawing, presents a plurality of through openings simply having the aim of discharge water which accumulates or condensate which is produced inside the drawn tubular element.

The present invention aims to overcome the drawbacks of the known technique mentioned above.

In particular, main purpose of the invention is to provide a casing for openings of buildings which keeps its own structural tightness characteristics unchanged over time or for a period of time definitely greater than that one allowed by the casing of the known art. Within this purpose, it is a first task of the present invention to create a casing for openings of buildings which presents a thermal insulation capacity better than that one of the known casings.

It is a second task of the present invention to make available a casing for openings of buildings in which the improvement of the thermal insulation capacity compared to the current state of the art is achieved without compromising the properties of mechanical strength, robustness, safety against vandalism, cost and ease of fabrication and installation of the casing. It is another task of the invention to concrete a casing for openings of buildings whose production process, unlike the equivalent prior art, eliminates any problem of toxicity.

It is a further task of the present invention to design a casing for openings of buildings which involves a high level of acoustic insulation for the room where it is installed.

It is also a task of the invention to provide a casing for openings of buildings which includes component elements on which it is possible to perform any processing or treatment of metallurgy, such as glazing. It is a last but not least purpose of the present invention to develop a casing for openings of buildings which allows to reduce, compared to the known art, the occurrence of condensation, avoiding the formation and proliferation of moulds and/or bacteria and the phenomena of steaming up of the surfaces of the glass slabs or panels housed inside one of the tubular section bars.

The aforesaid purposes are achieved by means of a casing for openings of buildings with enhanced thermal insulation capacity as the attached claim 1, to which they refer for the sake of brevity.

Further technical features of detail of the casing for openings of buildings of the invention are highlighted by the related dependent claims.

Advantageously, the casing of the invention assures excellent tightness characteristics in application conditions, when closed, higher than those ones of equivalent casings of the known type, while keeping adequate mechanical properties such as robustness and non-deformability and allowing an esae and not pollutant recovery of the constituting steel, since the section bars are not mixed up with plastic components more expensive and problematic, under the environmental impact point of view, to be separated.

At the same time, still advantageously, the casing of the invention offers a very effective thermal insulation, thanks to the presence of the through openings made in at least one of the two tubular section bars belonging to it.

Indeed, these through openings create a continuous flow of air which, due to the temperature difference between the inner environment and the outer environment, results in constant movement within the chamber defined by each of the tubular section bars: this improves with respect to the known art the overall performances of the casing or frame, in terms of thermal insulation both in summer and winter.

Moreover, in advantageous manner, the continuous and upward airflow inside the chamber of at least one of the tubular section bars is a continuous thermal barrier which provides perimetrical ventilation along the seat or side wall of housing of the front panel or slab, eliminating steaming up problems.

In substance, therefore, the through openings made in at least one of the two tubular section bars of the casing of the invention more specifically present a thermoregulating function of the inner room, scattering heat in a manner more efficient than what allowed by kwon type casings.

In the casing of the invention, the through openings have a thermoregulation function of the temperature e do not have a function of discharging the condensate or water, as it happens in document DT2129779; at the contrary, the same through openings of the casing of the invention try to prevent or at least strongly limit the appearance of such a phenomenon.

Equally advantageously, the casing for openings of buildings of the invention involves a saving of components and materials in comparison to similar casings of the known technique, thereby saving costs, the other factors being equal.

The aforesaid purposes and advantages, as well as others that will emerge later on, will appear more from the following description relating to a preferred embodiment of the casing for openings of buildings with enhanced thermal insulation capacity of the invention, given by illustrative and indicative, but not limited to, way with the help of the attached tables of drawing, where:

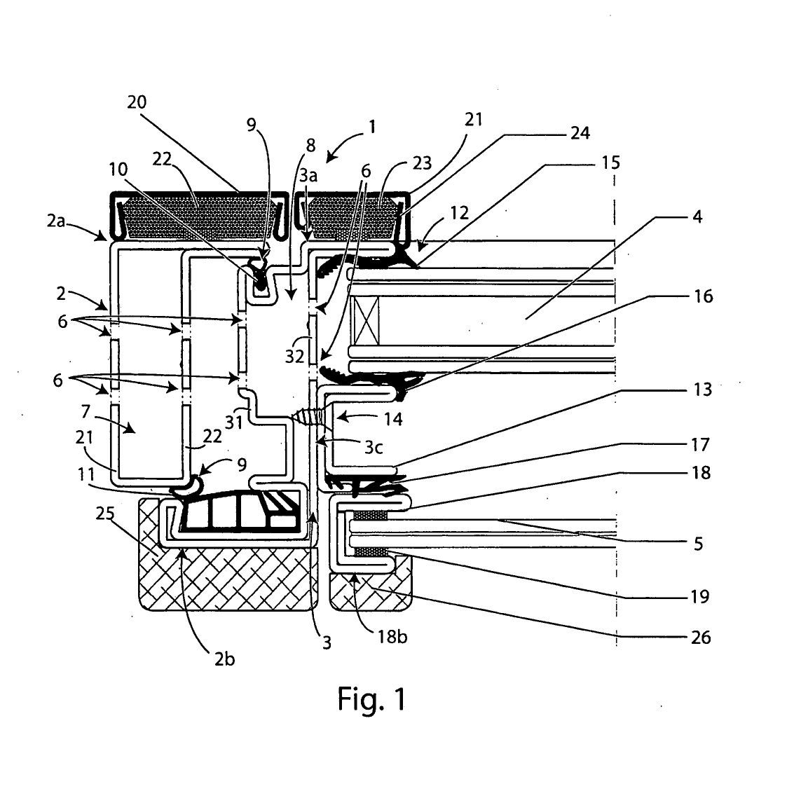

FIG. 1 is a cross section view of the casing of the invention;

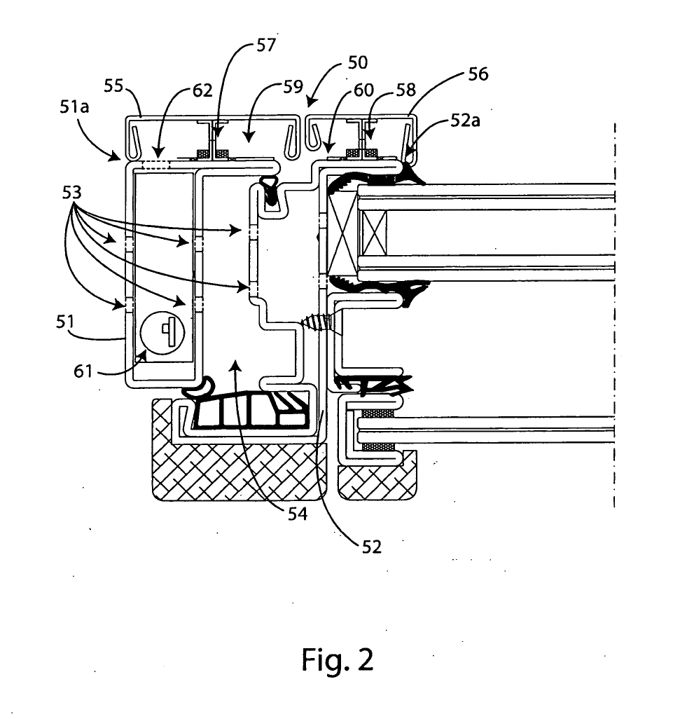

FIG. 2 is an executive variant of the casing of FIG. 1.

The casing for openings of buildings with enhanced thermal insulation capacity of the invention is illustrated in an its first embodiments in FIG. 1, where it is globally indicated with 1.

As can be seen, the casing 1 includes a first tubular section bar 2, which is fixed to the perimetrical wall delimiting the opening, and a second tubular section bar 3, cooperating with the first section bar 2 in order to hermetically close the opening and supporting in this case a pair of front panels 4, 5 of interface between the outer environment and the inner environment of the building.

According to the invention, the first section bar 2 and the second section bar 3 present a plurality of through openings 6 which create within each of them a continuous flow of circulating air which, due to the temperature difference between the inner environment and the outer environment, forms a natural thermal barrier in any astronomical season.

In practice, therefore, each of the tubular section bars 2, 3 defines a respective inner chamber 7, 8 communicating with the surrounding environment by means of the through openings 5 and in which the continuous flow of air forms said natural thermal barrier.

In particular, the aforesaid continuous flow of air is of upward kind.

The through openings 6 are made with special geometry, pace and sequence, as well as asymmetrically along two prefixed sections 21, 22 and 31, 32 opposite and facing each other of the tubular section bars 2, 3.

Preferably but not necessarily, each of the through openings 6 has a closed slot-shaped perimetrical profile.

FIG. 1 shows that, in this specific case, the first section bar 2 presents in cross section a substantially L-shaped profile, while the second section bar 3 presents, always in cross section, a substantially Z-shaped profile.

It is understood that in other embodiments of the invention, not illustrated, the first tubular section bar as well as the second section bar will present in cross section a profile different from that one just described: for example, the first section bar will present a substantially T-shaped T or Z-shaped profile, while the second section bar will present a substantially L-shaped or T-shaped profile.

More specifically, the tubular section bars 2, 3 are made of metallic material, e.g. steel of any alloy.

In a preferred but not binding way, the casing 1 comprises first sealing means, indicated overall with 9, interposed between the first tubular section bar 2 and the second tubular section bar 3.

More in detail, the first sealing means 9 include a pair of shaped strike seals 10, 11, not visible from the outside and placed close to the inner part of the tubular section bars 2, 3 from mutually opposite parts. At preferential title, the casing 1 also includes second sealing means, as a whole numbered with 12, interposed between the second tubular section bar 3 and the front panels 4, 5 and between each of the latter and an auxiliary separation section bar 13, coupled through fastening means, overall indicated with 14, with the side wall 3c of the second section bar 3 and interposed between the front panels 4, 5.

The second sealing means 12, of the type in itself known to the person skilled in the art, comprise, for example, a plurality of shaped seals 15, 16, 17; in particular, the shaped seal 15 is interposed between the second tubular section bar 3 and the front panel or slab 4, the shaped seal 16 is interposed between the auxiliary separation section bar 14 and a support section bar 18 which houses the front panel 5 through the interposition of an additional gasket or sponge 19 made for example of silicone.

Complete the casing 1 of the invention a pair of covering elements 20, 21, containing therein respective layers of insulating material 22, 23 externally coupled with the outer portion 2a, 3a of the tubular section bars 2, 3 through first gluing means, overall indicated with 24, as well as a pair of shaped bodies made of insulating material 25, 26, internally coupled with the inner portion 2b of the tubular section bar 2 and, in this case, the inner part 18b of the support section bar 18 through second gluing means, not shown for simplicity.

It is understood that in further embodiments of the invention, not represented, the casing may include only one covering element, arranged externally close to the outer portion of one of the tubular section bars. In addition, other embodiment of the casing of the invention, still not shown hereafter, will provide more than one covering element for each of the tubular section bars.

FIG. 2 shows a possible execution variant of the invention in which the casing, now globally numbered with 50, differs from that one just described and indicated with 1 firstly for the constructive composition of the covering elements 55, 56.

Indeed, in this case, the two covering elements 55, 56 are placed firmly and externally close to the outer portion 51a, 52a of the tubular section bars 51, 52 respectively, without the interposition of the layer of insulating material, as in the sample of casing 1 previously described.

In this regard, the casing 50 comprises a punched spacer 57, placed between the outer portion 51a of the tubular section bar 51 and the covering element 55 in order to determine the support thereof, creating an interstitial air zone 59 communicating with the outside.

Similarly, although in a preferred but not binding way, the covering element 56 is supported by the punched spacer 58 which creates the interstitial air zone 60 between the outer portion 52a and the covering element 56 itself.

Another important technical feature which differentiates the casing 50 of FIG. 2 from the casing 1 of FIG. 1 consists on the fact that the casing 50 includes forced ventilation means, as a whole numbered with 61, suitable to create an air recirculation between the outer environment and the inner environment, placed inside the tubular section bar 51 and communicating by means of the through openings 53 with the central compartment 54 defined between the tubular section bars 51 and 52.

The forced ventilation means 61, including for example a fan of the type in itself known, communicate also by means of a through slit 62, made in the outer portion 51a of the aforesaid tubular section bar 51, with the interstitial zone 59 defined between the outer portion 51a of the tubular section bar 51 and the covering element 55.

Unlike the known technique, the constructive aspect just described allows to keep hidden and protected from accidental impacts, atmospheric agents and/or dusts of various kinds, in application conditions, the forced ventilation means 61, without this affects the functional efficiency thereof, thus assuring an improvement in the aesthetic effect offered by the casing 50 as a whole.

In further embodiments, the casing of the invention may include forced ventilation means in both the tubular section bars, assuming as a consequence the presence of a through slit in the outer portion of each of them. In addition, in other embodiments, not illustrated in the appended drawings, the casing of the invention may include more than one punched spacer between at least one of the covering elements and the outer portion of the relative tubular section bar.

In alternative embodiments of the invention, not shown, the casing for openings of buildings with enhanced thermal insulation capacity could comprises a reference counter-frame, suitable to be contained into the perimetrical wall which delimits the opening and against which the first section bar rests, and/or at least one surface finishing element, coupled with the inner and/or outer wall of the second section bar: even the reference counter-frame and/or the finishing element could present one or more through aeration holes.

On the basis of what just described, it is, then, understood that the casing for openings of buildings with enhanced thermal insulation capacity, which is the object of the invention, achieves the purposes and reaches the advantages mentioned above.

In execution phase, changes can be made to the casing for openings of buildings with enhanced thermal insulation capacity consisting, for example, in a number of through openings different from that one mentioned above and illustrated in the attached drawings, this number could vary starting from one depending on application needs.

Other embodiments, not shown, of the casing here claimed may exist, in which only one of the two tubular section bars belonging to it presents one or more through openings for the air passage whose continuous flow and turbulence create the natural thermal barrier, which does not affect the advantages brought by the present invention.

It is clear that numerous other variations can be made to the casing for openings of buildings in exam, without for this reason going out of the novelty principles inherent to the inventive idea here expressed, as it is clear that, in the practical implementation of the invention, materials, shapes and sizes of the illustrated details can be any, as needed, and replaced with others technically equivalent.

Where the constructive features and the techniques mentioned in the following claims are followed by reference numbers or signs, those reference signs have been introduced with the sole objective of increasing the intelligibility of the claims themselves and therefore they have no limiting effect on the interpretation of each element identified, by way of example only, by these reference signs.

1-10. (canceled)

11. Closed-joint type casing for openings of buildings with enhanced thermal insulation capacity, including
a first tubular section bar made of metallic material, suitable for fixed to the perimetrical wall which delimits said opening,
a second tubular section bar made of metallic material, which cooperates with said first section bar in order to close said openings of buildings and supports one or more front panels of interface between the outer environment and the inner environment of said building,
one or more covering elements, placed firmly and externally close to the outer portion of at least one of said tubular section bars, and one or more shaped bodies made of insulating material coupled with the inner wall of at least one of
said tubular section bars, wherein at least one of said tubular first section bar and said second tubular section bar presents one or more through openings which create within at least one of said tubular section bars a continuous flow of circulating air which, due to the temperature difference between said inner environment and said outer environment, forms a natural thermal barrier in any astronomical season, said closed-joint type casing also including first sealing means interposed between said first tubular section bar and said second tubular section bar and at least one punched spacer interposed between said outer portion of at least one of said tubular section bars and at least one of said covering elements in order ermine the support thereof, creating an interstitial air zone communicating with the outside, characterized in that said closed-joint type casing comprises forced ventilation means, suitable to create an air recirculation between said inner environment and said outer environment, placed inside at least one of said tubular section bars and communicating by means of said through openings with a central compartment defined between said tubular section bars and by means of a through slit, made in said outer portion of at least one of said tubular section bars, with said interstitial air zone defined between said outer portion of at least one of said tubular section bars and at least one of said covering elements.

12. Casing as claimed in claim 11 wherein each of said tubular section bars defines an inner chamber which communicates with the surrounding environment through said through openings and in which said continuous flow of air forms said natural thermal barrier.

13. Casing as claimed in claim 11 wherein said continuous flow of air is of upward type.

14. Casing as claimed in claim 11 wherein said through openings are made asymmetrically along two prefixed sections opposite and facing each other of at least one of said tubular section bars.

15. Casing as claimed in claim 11 wherein each of said through openings presents a closed slot-shaped perimetrical profile.

16. Casing as claimed in claim 11 wherein said first section bar present in cross section a profile substantially in the form of L, T, Z.

17. Casing as claimed in claim 11 wherein said second section bar presents in cross section a profile substantially in the form of Z, L, T.

18. Casing as claimed in claim 11 wherein said first sealing means comprise a pair of ledge shaped gaskets, arranged close to said tubular section bars from parts opposite each other.

19. Casing as claimed in claim 11 wherein it comprises second sealing means interposed between said second tubular section bar and said front panels and/or between each of said front panels and an auxiliary separation element coupled through fastening means with said second section bar and interposed.

20. Casing as claimed in claim 11 wherein it comprises a reference counter-frame, suitable to be contained into said perimetrical wall which delimits said opening and against which said first section bar rests, and/or at least one surface finishing element, coupled with the inner and/or outer wall of said second section bar, said reference counter-frame and/or said finishing element presenting one or more through aeration holes.
